(19) United States
(12) Patent Application Publication
(10) Pub. No.: US 2023/0087046 A1
(43) Pub. Date: Mar. 23, 2023

(54) METHOD FOR ASSESSING THE QUALITY OF A COMPONENT OF OPTICAL MATERIAL

(71) Applicant: SCHOTT AG, Mainz (DE)

(72) Inventors: Thomas Korb, Partenheim (DE); Clemens Ottermann, Hattersheim (DE); Frank-Thomas Lentes, Bingen (DE); Nikolaus Schultz, Essenheim (DE)

(73) Assignee: SCHOTT AG, Mainz (DE)

(21) Appl. No.: 18/057,501

(22) Filed: Nov. 21, 2022

Related U.S. Application Data
(63) Continuation of application No. PCT/EP2020/064127, filed on May 20, 2020.

(51) Int. Cl. G01N 21/958; G01B 11/24; G01B 11/06; G01B 11/30; G01N 21/41; G01N 21/59

(52) U.S. Cl. CPC G01N 21/958; G01B 11/24; G01B 11/06; G01B 11/30; G01N 21/41; G01N 21/59; G01N 2201/0633; G01N 2201/103; G01N 2021/9511

(57) ABSTRACT

A method and system for assessing the quality of at least one component of optical material which has at least one first center axis includes directing at least one light beam towards at least one detector device such that while changing the position and/or orientation of the component relative to the light beam, the light beam crosses at least from time to time the component and determining, with at least one determination device, at least one characterizing value of at least one figure of merit of the component based on analyzing, with at least one analyzing device, the dependency of a parameter of the light beam detected by the detector device on the position and/or orientation of the component.

### CROSS-REFERENCE TO RELATED APPLICATIONS

This application is a continuation of International Application No. PCT/EP2020/064127, filed May 20, 2020, which is incorporated by reference herein in its entirety.

### BACKGROUND OF THE DISCLOSURE.

### 1. Field of the Disclosure

The present disclosure relates to a method for assessing the quality of at least one component of optical material. The disclosure relates also to a system for assessing the quality of such a component.

### 2. Description of Related Art

Components of optical material are widely used in the state of the art in various optical applications where a light beam passes though the optical material. For example, thin walled cylindrical tubes made from optical material, such as glass, which are transparent at least within a given spectral range in the UV, VIS or IR are used for providing optical windows particularly for LIDAR applications or for cylindrical optical scanners, e.g. in the field of printing technology. Here, the light source might be placed within the volume enclosed by the component of optical material, especially enclosed by the cylinder's shell. Further, containers of at least in part cylindrical shape, especially pharmaceutical containers, such as vials, syringes or flasks, might provide one or more optical windows or transparent portions for the purpose of inspection of the materials contained within the container from outside of the container. Here, the complete container or at least the optical windows might comprise respective components of optical material. For example the component of optical material might represent the entire container.

All these optical applications have in common that the components of optical material have to be of particularly high optical quality so that the light beam can pass the optical material without being distorted.

In this respect, aspects such as a uniform physical and optical thickness of the component, no significant (in terms of number and/or extension) local or global surface defects, a high roundness of cylindrical components, a high dregree of concentricity of inner and outer contour, a homogeneous material distribution and homogeneous optical properties are considered to be important criteria for assessing the quality of such components, just to name a few.

Conventionally, a number of different measurement methods have to be employed in order to verify a single component of optical material with respect to the most important sources of errors as the ones mentioned above. In addition, for components of different geometric shapes, often different measurement methods might be necessary. Particularly, in case of cylindrical or even arbitrarily shaped components, the handling of the respective shaped components and conducting the measurements is expensive and complicated, hence, highly inconvenient. The conventional methods are not appropriate in case that a large number of components has to be checked.

For example, in the state of the art the uniformity of the physical thickness of the component might be assessed by means of tactile measurement devices. Likewise, confocal measurement devices, chromatically distant determining devices and interferometry approaches have been proposed for quality assessment.

However, all these methods suffer from the fact that they are complex, not precise enough, provide only one single parameter of the component's quality, and often are not compatible with the requirement of a fast online quality assessment capability in the production environment.

Furthermore, especially for components used in LIDAR applications, it is often complicated to transfer the results obtained by conventional methods to a quality parameter that has a strong significance also for LIDAR applications.

It is, thus, an object of the present disclosure to overcome the disadvantages described above with respect to the state of the art by providing a method for assessing the quality of a component of optical material, which method is fast, reliable, easy to use, and that covers as many sources of errors as possible and also supports components of a large variety of shapes. It is also an objective of the present disclosure to provide a system for assessing the quality of such a component.

### SUMMARY OF THE DISCLOSURE.

The problem is solved by the disclosure according to a first aspect in that a method for assessing the quality of at least one component of optical material that has at least one first center axis, the method comprising: Directing at least one light beam towards at least one detector device such that while changing the position and/or orientation of the component relative to the light beam, the light beam crosses at least from time to time the component and determining, by means of at least one determination device, at least one characterizing value of at least one figure of merit of the component based on analyzing, by means of at least one analyzing device, the dependency of one or more parameters of the light beam detected by the detector device on the position and/or orientation of the component is proposed.

The disclosure is, thus, based on the surprising finding that information on all possible sources of errors are already contained in the light beam, once it has propagated through the material of the component (of optical material). This is true because each source of error, such as defects, optical inhomogeneities, variation in the thickness of walls and shells, imperfect roundness (in case of cylindrical components), impurities and the like, affect the light beam in a specific manner when it crosses the component, hence, lead to a modification of the light beam. Thus, analyzing the light beam with respect to one or more parameters after the light beam crosses the component at different locations allows detailed information to be obtained with respect to one (or more) specific figures of merit that in turn can be arbitrarily chosen dependent on which quality aspect of the component is of interest.

This is highly convenient because the evaluation of the light beam's parameters is completely independent of the component itself, especially its shape, its size or its material. Moreover, it is astonishing that the figure of merit of interest, i.e. the quality aspect to be determined of the component, can be completely decoupled from the respective errors' nature and can, thus, be determined based on appropriate parameters of the light beam.

The parameters of the light beam can be evaluated in a straight forward manner with conventional means and always in the same manner for all types of components. Furthermore, there is no need to conduct different types of measurements in order to obtain information on individual sources of errors. This in turn allows a more cost-effective and universal setup.

It is a particularly beneficial aspect that the individual sources of errors, indeed, have to be known neither a priori nor a posteriori. Every source of error that affects the light beam in the real application affects the light beam likewise during the test and is, hence, covered by the evaluation of the light beam's parameters. This is highly appreciated because even if a source of error, if regarded individually by conventional means, is potentially or actually significant for the quality of a component under test, in an overall assessment of the quality, as obtained by the proposed disclosure, this source of error might be revealed to be of no significance - for example because it zeros out with other error contributions. This leads to fewer rejects from customers.

Furthermore, analyzing the light beam allows working directly on the raw data, i.e. the light beam's parameter. There is no need to deal with complex and computationally expensive signal processing techniques in order to determine the characterizing value of the desired figure of merit. In addition, the quality assessment can be directly transferred to the actual application. This is particularly important for LIDAR applications.

The proposed approach is easy to implement, fast, cheap, reliable and more accurate than conventional approaches. Only one single setup is required for determining the significance of all possible errors of a component. Furthermore, also an online quality assessment is possible, which can even be run in a highly automated manner.

In one embodiment it might alternatively or in addition be preferred that directing the at least one light beam comprises routing the light beam from its at least one light source to the detector device via at least one optical element, especially the optical element comprises at least one prism, especially at least one pentaprism, and/or at least one mirror, and wherein preferably (i) the optical element is fixedly located relative to the light beam, the light source and/or the detector device; (ii) the optical element is located (aa) at least in part and/or (bb) at least from time to time within at least one volume enclosed by the component; (iii) the optical element is located before or after the component along the path of propagation of the light beam; (iv) the light beam is incident on the optical element along a direction parallel to the first center axis of the component; (v) the light beam is incident on the optical element along a direction perpendicular to the first center axis of the component; (vi) the light beam is deflected by the optical element in a direction (aa) perpendicular to the direction of incidence of the light beam, (bb) perpendicular to the first center axis of the component and/or (cc) parallel to the first center axis of the component; and/or (vii) the optical element deflects the light beam such that it crosses the component always in a manner perpendicular to at least one local surface area of the component.

Using an optical element allows for assessing the quality of components (of optical material) that are complicated to handle. For example, an optical element might be used to deflect the beam in an appropriate way so that it crosses the component properly (such as its shell in case of a component of cylindrical shape). This can be advantageously accomplished for example by using a prism or a mirror.

If the optical element is fixedly located relative to the light beam, the light source and/or the detector device, a robust setup can be obtained, hence precise measurements can be conducted, since the number of moveable parts is reduced.

Components enclosing some hollow space can be measured in a preferred manner if the optical element is located within the respective volume. For example components of cylindrical shape are one type of components in that respect. Of course, while the position and/or orientation of the component is changed, it might happen that parts of the optical element either permanently or from time to time are outside of the volume. However, this is acceptable, if the light beam still crosses the component properly during the respective measurements for assessing the quality of the component.

For components shaped in some specific manner, especially without enclosing any hollow space, e.g. components of cubical shape, the optical element might be located such that the light beam is directed through the component properly in that the optical element is located before or after the component.

If the optical element deflects the light beam such that it crosses the component substantially always in a manner perpendicular to at least one local surface area of the component, the measurements can be conducted in a defined and reliable manner.

In one embodiment it is alternatively or in addition preferred that the light beam is incident on the optical element along a direction parallel to the first center axis of the component, and that the light beam is deflected by the optical element in a direction perpendicular to the direction of incidence of the light beam.

In one embodiment it is alternatively or in addition preferred that the light beam is incident on the optical element along a direction perpendicular to the first center axis of the component, and that the light beam is deflected by the optical element in a direction perpendicular to the direction of incidence of the light beam.

In one embodiment it might alternatively or in addition be preferred that (i) when the light beam crosses the component, the light beam propagates through at least one thickness range of the component, especially through at least one wall or shell of the component; and/or (ii) the light beam always crosses the component and/or crosses the component at different locations for different instances of time.

If the light beam propagates through the thickness range, i.e. through the material, of the component, the information concerning the quality of the component at the particular location can be “collected”.

Especially if in later applications a light beam is emitted from inside of the component to the outside (e.g. in LIDAR applications), the quality of the wall (including its surfaces) is exactly the crucial aspect that has to be investigated.

In one embodiment it might alternatively or in addition be preferred that (i) the component is fixedly attached to at least one positioning device, wherein preferably changing the position and/or orientation of the component comprises actuating the positioning device and/or changing the position and/or orientation of the positioning device; (ii) the component comprises as material glass, glass ceramic and/or polymer, especially the material is at least in part transparent for the light beam, preferably in the UV, VIS and/or IR frequency range; and/or (iii) the component is of cylindrical shape, especially having at least one wall or shell, and/or of non-cylindrical shape, especially of flat and/or cubic shape.

A positioning device is useful for carrying out the movements, i.e. changing position and/or orientation of the component, in a precise and repetitive manner.

A component of cylindrical shape is preferred for certain applications, e.g. for LIDAR applications.

In one embodiment it might alternatively or in addition be preferred that (i) changing the position of the component comprises changing the position of the component along at least one first direction, especially the first direction is parallel to the first center axis of the component, preferably by displacing the positioning device along the first direction; (ii) changing the position of the component comprises changing the position of the component along at least one second direction, especially the second direction is perpendicular to the first direction and/or to the first center axis of the component, preferably by displacing the positioning device along the second direction; (iii) changing the orientation of the component comprises rotating the component around its first center axis and/or around at least one axis parallel to the incident or the exiting light beam, preferably by rotating the positioning device around the first center axis and/or around at least one axis parallel to the incident or the exiting light beam; (iv) changing the position and/or orientation of the component comprises changing the position of the component along the first direction and changing the orientation of the component, preferably parallel and/or sequentially; and/or (v) changing the position and/or orientation of the component comprises changing the position of the component along the first and the second direction, preferably parallel and/or sequential..

For the purpose of the present disclosure, the first direction refers to at least one of the directions along which the position of the component is changed, unless otherwise stated in individual cases or apparent from the context.

For the purpose of the present disclosure, the second direction refers to at least one of the directions along which the position of the component is changed, unless otherwise stated in individual cases or apparent from the context.

In one embodiment, changing the orientation of the component comprises rotating the component around its first center axis, preferably by rotating the positioning device around the first center axis.

In one embodiment preferably changing the orientation of the component comprises rotating the component around at least one axis parallel to the incident light beam, preferably by rotating the positioning device around the at least one axis parallel to the incident light beam.

In one embodiment, changing the orientation of the component comprises rotating the component around at least one axis parallel to the exiting light beam, preferably by rotating the positioning device around the at least one axis parallel to the exiting light beam.

In one embodiment it might alternatively or in addition be preferred that the detector device has at least one detecting plane for detecting the light beam incident to the detector device, preferably the detecting plane is perpendicular to the incident light beam, wherein preferably the cross-section of the light beam within the detecting plane has a position, especially the position of its center and/or the position of its center of gravity, preferably relative to a reference position, which position of the cross-section is indicated by at least one first coordinate value on a first coordinate axis and/or at least one second coordinate value on a second coordinate axis, and wherein preferably the first coordinate axis is along a third direction and/or the second coordinate axis is along a fourth direction, preferably the third direction is perpendicular to the first center axis of the component and/or the fourth direction is perpendicular to the third direction and/or parallel to the first direction.

The detecting plane is the location where the light beam is evaluated by the detector device. For example, this can be one or more optical sensors, that is/are capable of and/or configured to detecting the light beam.

For example the detector device might be a 2D detector array for 2D detection of the intensity distribution of the cross section in the detecting plane.

If the position of the cross-section of the light beam corresponds to the position of the center of the cross-section of the light beam, this means the center of the smallest circle which circumferences the entire cross-section of the light beam.

The reference position might be the origin of coordinates of the first and/or second coordinate axis.

In one embodiment it might alternatively or in addition be preferred that the one or more parameter is or are selected from the group consisting of (a) the area of at least one cross-section of the light beam, especially the shape, the size, such as the absolute value of the largest extension, the direction of the largest extension, the ovality and/or the sharpness of the border of, respectively, the area, wherein the cross-section lies within the detecting plane of the detector device, (b) the position, especially the first and/or second coordinate value, of the cross-section of the light beam within the detecting plane, and/or (c) the intensity distribution of the light beam in the detecting plane.

Parameters always refer to certain aspects of the light beam. These can include aspects that are inherent to the light beam itself (i.e. such aspects can be determined only with the beam available for further investigations) such as the shape of a (2D) cross-section of the light beam or the intensity distribution of the cross-section of the light beam. However, parameters can also refer to aspects that are related to references that are not provided by the light beam. An example for the latter is the position of the cross-section, which is not an inherent property of the light beam but requires some references (e.g. detecting plane and/or one or more coordinate axis).

In one embodiment it is alternatively or in addition preferred that the parameter is the shape of the area of the cross-section of the light beam in the detecting plane.

In one embodiment it is alternatively or in addition preferred that the parameter is the ovality of the area of the cross-section of the light beam in the detecting plane.

In one embodiment it is alternatively or in addition preferred that the parameter is the largest extension of the area of the cross-section of the light beam in the detecting plane.

In one embodiment it is alternatively or in addition preferred that the parameter is the sharpness of the border of the area of the cross-section of the light beam in the detecting plane.

In one embodiment it is alternatively or in addition preferred that the parameter is the position of the cross-section of the light beam in the detecting plane.

In one embodiment it is alternatively or in addition preferred that the parameter is the intensity distribution of the light beam in the detecting plane. Of course, this is a 2D intensity distribution.

For example, the parameters might be determined in that the detector device comprises at least one 2D detector unit, especially comprising an array of pixels, which 2D detector unit is configured to determine the position, the shape and/or the intensity distribution of the cross-section of the light beam in the detecting plane.

It is clear for the person skilled in the art that a measurement of the intensity distribution of a cross-section of the light beam might determine the exact distribution or can cut off typically the edge with lower intensities (where intensity drops to say 10% or 1/e).

In one embodiment it might alternatively or in addition be preferred that the figure of merit is directed to
local inhomogeneities, such as at least one local thickness and/or at least one local refraction index, especially at least one local thickness variation and/or at least one local refraction index variation, of,
local deviation from a nominally ideal shaped component of,
local deviation from a cylindric design of,
local defects, such as bubbles and/or knots, in,
local and/or global roundness of,
local slope error of,
local drawing lines on,
local shape errors of,
local artifacts of,
local light transmission properties of,
local striae of,
local scratches on,
local variation of physical thickness of,
local variation of optical thickness of, and/or
local impurities, such as stones and/or pieces of metal, in, respectively, the component.

For example, a local deviation from a nominally ideal shape might be a deviation from a component of ideal cylindrical or cubical shape if the component under examination is at least in general, respectively, of cylindrical or cubical shape. In this respect, ripples extending on the component along the first center axis might lead to a deviation of the light beam along the third direction while the component is rotated. In general, local deviations might also be referred to as local (differentially) geometry errors as slope error: deviation of wave front and/or surface slope from ideal geometry at lateral dimensions within a fraction of the size of the overall size of the object.

For example, a defect might weaken the intensity and/or modifying the intensity distribution, respectively, of the light spot of the light beam at the detector device, especially within the detecting plane. Alternatively or in addition a defect might also cause the light beam be scattered at least in part which in turn might lead to a light spot of the light beam which light spot is widened in diameter and/or has some aura or the like compared to a light spot of an unaffected light beam. Hence, the sharpness of the border of the area of the cross-section might be modified.

For example, a local slope error refers to a local variation of the material thickness of the component, especially the thickness of a wall or shell of the component, compared to the material thickness distribution of the respective nominally ideal shape. Especially the variation in thickness means a variation of the thickness along a length, which allows to calculate an angle, i.e. the slope error.

In other words: The slope error might also be referred to as tangent error and describes a local slope deviation from an ideal target slope or a change of the wall thickness along a length section, for example a circumferential section (wall thickness variation). When considering and determining the slope error, the ideal area on the particular area of the element/optical window is used as reference area. In the case the optical window being a cylindrical element this would be a mathematical perfect ring with continuously identical nominal radius of curvature.

The local slope error might also be regarded as the combined error of outside and inside slope of surface. It is noted that if the slopes are parallel the error is likely less critical as if slopes are tilted against each other.

For example, drawing lines might constitute ripples extending on the component along the first center axis. For example, from peak to peak the amplitudes can be within the range of 20 to 500 nm and/or having a spatial wavelength of between 0.3 to 2 mm. The ripples might lead to a deviation of the light beam along the third direction while the component is rotated. The ripples might originate from the glass drawing process in case the component comprises or is a cylindrical glass tube element.

A shape error is any deviation from perfect/desired shape. For example, a shape error might correspond to ovalities, i.e. non-optimal roundness of for example cylindrical or tubular components. In this respect, components having shape errors such as ovalities might lead to a deviation of the light beam along the third direction compared to a component of nominally ideal shape. For example, a light beam directed from the inside of a component of cylindrical shape radially outwards always impinges perpendicularly on the component, hence, is not deflected. However, in case the component is at least in part of oval shape, the light beam is deflected along the third axis (i.e. perpendicular to the first center axis of the component).

For example, artifacts might be defects of the inner and/or outer surface of the component, such as scratches or digs, i.e. defects of hemispherical shape.

For example, ripples as stripes on both wall surfaces might originate from a glass drawing process in case the component is or comprises a glass tube element.

From a more general point of view, the following aspects might provide important insights in how to obtain an appropriate figure of merit.

The optical wavefront w of the optical window with refractive index n and the geometrical thickness t might be defined by

w=(n−nₐ)·t

If it is assumed that both surfaces are surrounded by air or vacuum; then n_a can be approximated by n_a≈1:

w=(n−1)·t

Scattering due to surface defects (e.g. scratches) and bulk scattering is neglected here.

The most important quantity to describe the wave front error is called slope error (SE). It is the lateral variation of the optical wave front (here in x-direction, generally dw/dx) has to be replaced by the gradient \vec{∇}w) defined by

SE=dw/dx=dn/dx·t+(n−1)dt/dx

SE=dw/dx=dn/dx·w/(n−1)+w/t·dt/dx=w·(1/(n−1)·dn/dx+1/t·dt/dx)

There are two main contributions: in many cases the major part of slope error comes from lateral local variations of the thickness dt/dx whereas material inhomogeneities dn/dx can contribute to the total slope error in some cases.

In one embodiment it might alternatively or in addition be preferred that the characterizing value is at least one quantitative value of the figure of merit and/or is at least one qualitative value of the figure of merit, such as one or more of: “good”, “very good”, “bad”, “worse”, “worst”, “very few”, “few”, “some” and “many”.

Preferably, the characterizing value can be a quantitative value of the figure of merit such as the value of the (maximal) deflection of the light beam (preferably at the detector device, especially in the detecting plane) from some reference position while the position and/or orientation of the component is changed. Preferably the reference position is determined based on the light beam (e.g. the position of the light beam, preferably at the detector device, especially in the detecting plane) when no component, a component of ideal quality, and/or a component of just about acceptable quality is present.

Preferably, for the characterizing value a qualitative value might be chosen based on whether or not the quantitative value is above a certain threshold value.

Preferably, the characterizing value can be a qualitative value of the figure of merit which qualitative value can also be chosen based on whether or not a quantitative value of the parameter's dependency is greater than a maximum value of some test component which has a maximal allowable deviation of at least one parameter under consideration.

In one embodiment it might alternatively or in addition be preferred that analyzing the dependency comprises obtaining and/or evaluating the variation each of the one or more parameter(s) detected by the detector device has across the different positions and/or orientations of the component, especially the variation (a) is obtained or evaluated with respect to some reference of the respective parameter and/or (b) is described by the difference between the maximal and minimal values the respective parameter has for the different positions and/or orientations of the component.

If the variation of the parameter is obtained and/or evaluated, the dependency of the parameter can be analyzed in a precise and reliable manner.

If the reference of the respective parameter is incorporated, a defined starting point is used which allows for comparison between the variation of a parameter for different components of the same (nominal) type. In one embodiment, the reference is obtained for a component of ideal form. Of course, “ideal” here means from a practical point of view, especially with respect to a component which is regarded as being ideal from a practical point of view.

Describing the variation by the difference between the maximal and minimal values is very descriptive and easy to use for further processing. In addition, the difference represents a format which can be obtained efficiently and repetitively in a reliable manner.

In one embodiment, the size of the area of at least one cross-section of the light beam in the detecting plane is used as parameter for assessing the quality of a certain type of component. Then, the variation of the size, e.g. an increase/decrease of the largest extension of the area, while changing the position and/or orientation of the component might be evaluated. Especially, alternatively or in addition the variation might be compared to a reference area which can be obtained for an ideal component of the type under test. Of course, again “ideal” means from a practical point of view.

In one embodiment preferably the position of at least one cross-section of the light beam in the detecting plane is used as parameter for assessing the quality of a certain type of component. Then, the variation of the first coordinate value and/or the second coordinate value while changing the position and/or orientation of the component might be evaluated. Especially, alternatively or in addition the variation might be compared to a reference position which might be obtained for an ideal component of the type under test. Of course, again “ideal” means from a practical point of view.

In one embodiment, the intensity distribution of the light beam in the detecting plane is used as parameter for assessing the quality of a certain type of component. Then, the variation of the intensity distribution while changing the position and/or orientation of the component might be evaluated. Especially, alternatively or in addition the variation might be compared to a reference intensity distribution which might be obtained for an ideal component of the type under test. Of course, again “ideal” means from a practical point of view.

Example: There might be a cross-section of ideal area of the light beam for an ideal component, e.g. a component of cylindrical form. Say this (ideal) cross-section might have a circular area. A variation of the area of the cross-section while changing the position and/or orientation of the component might be expressed for example by (i) a change of the shape of the area of the cross-section, (ii) its maximal and/or minimal size of the largest extension, (iii) its maximal and/or minimal ovality (preferably along with an angle of the main axis to at least one reference direction), and/or (iv) its minimal and/or maximal sharpness in the border of the area.

In one embodiment it might alternatively or in addition be preferred that determining the characterizing value of the figure of merit comprises (a) using the variation of the parameter as the characterizing value and/or (b) comparing the result obtained from analyzing the dependency, especially the variation of the parameter, against at least one or more qualitative and/or quantitative reference means, preferably the quantitative reference means comprises at least one look-up table, at least one upper threshold value and/or at least one lower threshold value.

It is the finding that there are different possibilities to cast/convert the result or any other type of outcome of analyzing the dependency into the characterizing value. Especially it is the finding that the result or in general the outcome of analyzing the dependency can be of any type of information. It is not necessary that the information has the same units or dimension as the characterizing value of the figure of merit (although it might be the case). Instead, the characterizing value is determined based on the result/outcome of analyzing the dependency. This “determining” might then incorporate some kind of casting or conversion.

Using the variation of the parameter as the characterizing value is a quite direct approach which is easy to implement and reliable.

If the result obtained from analyzing the dependency is compared against qualitative / quantitative reference means, the characterizing value of the figure of merit can be obtained in a very efficient and reliable manner. Furthermore, also the characterizing value itself is more reliable in that case. This is inter alia because a clear judgment is possible which can be implemented in an efficient and also easy manner.

If the reference means comprises thresholds, the determination of the characterizing value is reduced to one or more single judgments, and each judgment can be made very easily and in a comfortable manner. Especially, it is possible to realize a binary characterizing value. I.e. either one (1) or zero (0) which might indicate a high or low quality component respectively at least with respect to at least one figure of merit. For example, the reference means can be a just about acceptable threshold value for a value of the parameter.

If the reference means comprises look-up-tables, the characterizing value can be determined very fast and in any desired gradation / increments which can be adjusted by simply amending the look-up table. For example, for different (ranges of) variations of each of one or more parameters, different characterizing values might be stored in the table and looked up quickly and reliably.

In one embodiment it might alternatively or in addition be preferred that (i) the parameter is the first coordinate value of the position of the cross-section of the light beam in the detecting plane and whose dependency on different positions along the first and/or second direction of the component and/or orientations of the component around its first center axis is analyzed for determining the characterizing value of the local deviation from a cylindrical design, the roundness, the slope error and/or the drawing lines, respectively, of the component; (ii) the parameter is the second coordinate value of the position of the cross-section of the light beam in the detecting plane and whose dependency on different positions along the first and/or second direction of the component and/or orientations of the component around its first center axis is analyzed for determining the characterizing value of the local deviation from a cylindrical design, the roundness, the slope error and/or the drawing lines, respectively, of the component; (iii) the parameter is the area of the cross-section of the light beam in the detecting plane and whose dependency on different positions along the first and/or second direction of the component and/or orientations of the component around its first center axis is analyzed for determining the characterizing value of local deviation from a cylindric design and/or local defects, respectively, of the component; and/or (iv) the parameter is the intensity distribution of the light beam in the detecting plane and whose dependency on different positions along the first and/or second direction of the component and/or orientations of the component around its first center axis is analyzed for determining the characterizing value of local defects and/or at least one light transmission property, respectively, of the component.

It is astonishing that based on changing the position and/or orientation of a component a reliable statement can be made with respect to a characterizing value of a figure of merit of the component if appropriate pairs of parameters and figures of merit are chosen. Moreover, it might also be possible that more than one parameter is incorporated, hence, the characterizing value of the figure of merit might be determined based on analyzing more than one parameter. This indeed might improve the reliability of the characterizing value.

In one embodiment, it might alternatively or in addition be preferred that the parameter is the first coordinate value of the cross-section of the light beam in the detecting plane and whose dependency on different orientations of the component around its first center axis is analyzed for determining the characterizing value of local deviation from a cylindrical design, local slope error and/or drawing lines, respectively of the component.

In one embodiment it might alternatively or in addition be preferred that the parameter is the second coordinate value of the cross-section of the light beam in the detecting plane and whose dependency on different positions along the first and/or second direction of the component is analyzed for determining the characterizing value of local shape errors and/or artifacts, respectively, of the component.

In one embodiment it might alternatively or in addition be preferred that the parameter is the intensity distribution of the cross-section of the light beam in the detecting plane and whose dependency on different positions along the first and/or second direction of the component and/or orientations of the component around its first center axis is analyzed for determining the characterizing value of local light transmission properties of the component.

In one embodiment it might alternatively or in addition be preferred that the parameter is the ovality of the area of the cross-section of the light beam in the detecting plane and whose dependency on different positions along the first and/or second direction of the component and/or orientations of the component around its first center axis is analyzed for determining the characterizing value of local shape errors of the component.

In one embodiment it might alternatively or in addition be preferred that (i) the light beam comprises at least one laser beam, especially the laser beam comprises light of wavelength 840 nm, 905 nm and/or 1550 nm; (ii) the light beam is emitted from at least one light source, comprising at least one white light source, preferably the light source is used (a) in combination with at least one filter for setting up at least one wavelength comprised by the light beam and/or (b) in combination with one or more optical parts placed within the path of the light beam, especially for beam forming; and/or (iii) directing the at least one light beam comprises directing two or more light beams, especially parallel ones, towards the detector device, wherein especially the two or more light beams cross at the same instance of time the component at different locations along the first and/or second direction.

If a light beam of particular wavelength is used, the same wavelength as used in specific applications such as LIDAR applications can be used for assessing the quality of the component.

Using optical parts for beam forming is particularly preferred because the light beam can be shaped as to match the geometries of the component under test. Furthermore, such optical parts might be used in combination with a light source being a white light source.

If more than one light beam is used, the method can be sped up significantly because the component under evaluation can be evaluated at different spatial locations at the same time. This reduces the required measurement time.

In one embodiment it might be preferred that more than one light beam is used, wherein preferably the light beams are running in parallel to the detector device.

In one embodiment it might alternatively or in addition be preferred that (i) the method further comprises: controlling the intensity of the laser beam based on the intensity of the light beam incident on the detector device, especially incident on the detecting plane; (ii) at least one attenuation filter is arranged within the light beam path before the detector device for attenuating the incident light beam; (iii) at least one scattered light filter is arranged within the light beam path before the detector device in order to prevent scattered light reaching the detector device, especially the detection plane; (iv) the detector device comprises at least one 2D detector unit, especially comprising an array of pixels, which 2D detector unit is preferably configured or configurable to determine the position, the shape and/or the intensity distribution of the cross-section of the light beam in the detecting plane; (v) the detector device comprises at least one position sensitive detector array, such as at least one four-quadrant-photo-diode, at least one camera device and/or at least one line sensor; (vi) two or all of the determination device, the analyzing device and the detector device are designed at least in part as one single device; (vii) the shortest distance between the component and the detector device, especially the detecting plane, is constant while changing the position and/or orientation of the component, especially while changing the position along the first and/or second direction and/or while changing the orientation around the first center axis, and wherein preferably all angles of the optical path are constant while changing the position and/or orientation; (viii) the shortest distance between the component and the detector device, especially the detection plane, is between 1 cm and 100 m, preferably between 1 cm and 10 m, more preferably between 1 cm and 10 cm or between 2 m and 6 m, especially between 2 m and 4 m; and/or (ix) at least one holder device is provided, preferably designed in one piece with at least one part of the positioning device, for holding the component, especially for holding the component in a position such that the component is always concentric with the incident and/or exiting light beam.

Controlling the intensity distribution allows the application of the proposed method to components of different absorption coefficients without any further arrangements or preparations required in advance.

A position sensitive detector array is fast and easy to use and allows a direct measurement of the one or more position parameter (e.g. x value and y value).

A camera allows recording comprehensive information of the light beam, especially of its cross-section in the detecting plane.

In one embodiment it might be preferred that more than one camera is comprised by the detector device. This is especially preferred if more than one light beam is used and in the detector device each light beam is detected by an individual camera. For example, two cameras for two light beams.

For example, the detector device might comprises at least one 2D detector unit, especially comprising an array of pixels, which 2D detector unit preferably is configured to determine the position, the shape and/or the intensity distribution of the cross-section of the light beam in the detecting plane.

Preferably, the term “shortest distance” here refers to the shortest distance measured between any two points on the detector device, especially the detecting plane, and the component.

The problem is solved by the disclosure according to a second aspect in that a system for assessing the quality of at least one component of optical material, especially for carrying out and/or configured to carry out, respectively, a method according to the first aspect of the disclosure, the system comprising:
at least one holder device for holding the component;
at least one detector device;
at least one light source which emits at least one light beam, wherein the at least one light beam is directed towards the at least one detector device such that the light beam crosses the component at least from time to time if it is held by the holder device;
at least one positioning device, for and/or configured to changing the position and/or orientation of the component, especially while the component is held by the holder device, relative to the light beam;
at least one analyzing device, preferably configured to analyze the dependency of one or more parameters of the light beam detected by the detector device on the position and/or orientation of the component; and
at least one determination device, preferably configured to determining at least one characterizing value of at least one figure of merit of the component based on at least one result obtained from the analyzing device is proposed.
   Surprisingly, it was found that a setup comprising convenient means allows for the assessment of the quality in a highly efficient and accelerated manner, as discussed above with respect to the first aspect of the disclosure.

In one embodiment it might alternatively or in addition be preferred that (i) the at least one light beam is directed from its at least one light source to the detector device via at least one optical element, especially the optical element comprises at least one prism, especially at least one prism with an even number of reflective surfaces or at least one pentaprism, and/or at least one mirror, preferably with one reflective surface; (ii) the system is of low vibration, especially vibration-free; (iii) the system further comprises at least one attenuation filter which is arranged within the light beam path before the detector device for attenuating the incident light beam; and/or (iv) the system further comprises at least one scattered light filter which is arranged within the light beam path before the detector device in order to prevent scattered light reaching the detector device, especially the detection plane.

### BRIEF DESCRIPTION OF THE DRAWINGS

Various aspects of this disclosure will become apparent to those skilled in the art from the following detailed description of a preferred embodiment, when read in light of the accompanying schematic drawings.

FIG. 1 shows a system according to the present disclosure in a first configuration for a first type of component for carrying out a method according to the present disclosure.

FIG. 2 shows a system according to the present disclosure in a second configuration for a second type of component for carrying out a method according to the present disclosure.

FIG. 3 shows a diagram of the variation of a selected parameter for components of the same type but of different quality.

### DETAILED DESCRIPTION OF THE DISCLOSURE

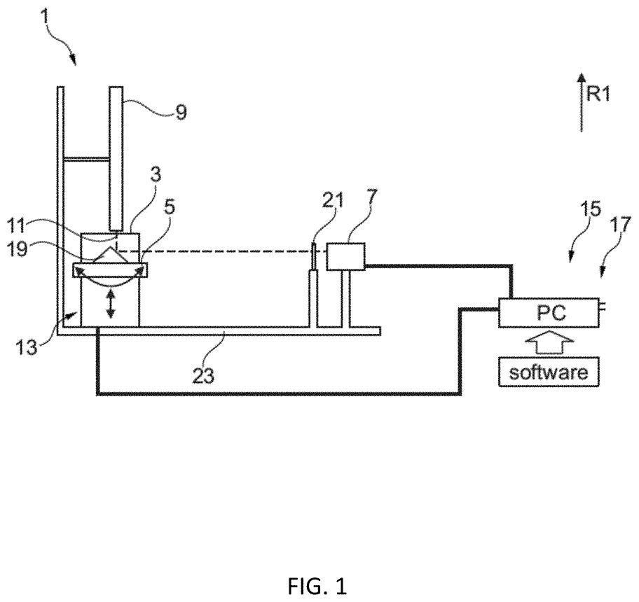

FIG. 1 shows a system 1 in a first configuration for assessing the quality of at least one component of optical material 3 of a first type.

The component (of optical material) 3 whose quality can be assessed with the system 1 is of cylindrical shape and has a shell (i.e. first type component). The component 3 has a first center axis which in FIG. 1 runs along a direction parallel to direction R1 (i.e. a vertical direction in FIG. 1).

The system 1 comprises a holder device 5 for holding the component 3. In FIG. 1 this holder device is in form of a table.

The system 1 comprises a detector device 7 and a light source 9 which emits a light beam 11, wherein the light beam 11 is directed towards the detector device 7 such that the light beam 11 crosses the component 3 at least from time to time if it is held by the holder device 5. The light source might be realized in form of a laser, for example having a wavelength of 633 nm.

The detector device 7 has a detecting plane for detecting the light beam 11 incident to the detector device 7. The detecting plane is perpendicular to the incident light beam 11. For example the detector device 7 comprises a 2D detector unit which comprises an array of pixels. This allows that the detector device 7 can determine the position, the shape and/or the intensity distribution of the cross-section of the light beam 11 in the detecting plane.

The system 1 further comprises a positioning device 13, for changing the position along the first direction R1 and the orientation of the component 3, while the component 3 is held by the holder device 5, relative to the light beam 11. The positioning device 13 is realized in form of a rotary and height-adjustable table (see the arrows indicated at the positioning device 13 for illustration purposes). Indeed, the holder device 5 is designed in one piece with at least one part of the positioning device 13, i.e. the table function as holder device 5 and at the same time also functions as positioning device 13.

The system 1 also comprises an analyzing device 15 which is configured to analyze the dependency of one or more parameters of the light beam 11 detected by the detector device 7 on the position and/or orientation of the component 3.

The system 1 also comprises a determination device 17 which is configured to determine at least one characterizing value of at least one figure of merit of the component 3 based on at least one result obtained from the analyzing device 15.

Indeed, the analyzing device 15 and the determination device 17 are designed as one single device which might be a personal computer having some hardware and some software installed. The analyzing device 15 and determination device 17 might be connected with each other and/or with the detector device 7 and the positioning device 13 as indicated by solid lines in FIG. 1 for the purpose of transmitting and exchanging control data and receiving data of the detector device 13.

In the system 1 the light beam 11 is directed from its light source 9 to the detector device 7 via an optical element 19. The optical element 19 comprises a prism such as a pentaprism but it might alternatively or in addition also comprise a mirror.

Optionally, the system 1 further comprises a filter 21 which is arranged within the light beam path before the detector device 7. The filter 21 might be in form of an attenuation filter for attenuating the incident light beam 11. Alternatively or in addition the filter might be in form of a scattered light filter to prevent scattered light reaching the detector device 7.

Inter alia due to one or more optional mounting elements 23, the system 1 experiences/undergoes a minimum oscillation/vibration during use.

In the system 1 the light beam 11 is incident on the optical element 19 along a direction parallel to the first center axis of the component 3, i.e. parallel to direction R1, and the light beam 11 is deflected by the optical element 19 in a direction perpendicular to the direction R1 of incidence of the light beam 11 (which is also a direction perpendicular to the first center axis of the component 3).

Of course, for the sake of completeness it is acknowledged that there might be possible modifications of system 1 so that for cylindrical components the light beam 11 is incident on the optical element 19 along a direction perpendicular to the first center axis of the component and where the light beam 11 is deflected by the optical element 19 in a direction parallel to the first center axis of the component. In other words, such a modification of system 1 might be suitable for scenarios where the cylindrical component 3 is rotated by 90 degrees in the picture plane of FIG. 1 along with an appropriate modification of the positioning device 13.

The light beam 11 always crosses the component 3 (particularly the shell thereof) and by displaying and/or rotating the component 3, the light beam 11 crosses the component at different locations. Hence, the detector device 7 can evaluate the quality of the component at different locations by evaluating the light beam. This allows an overall assessment of the quality of the component 3.

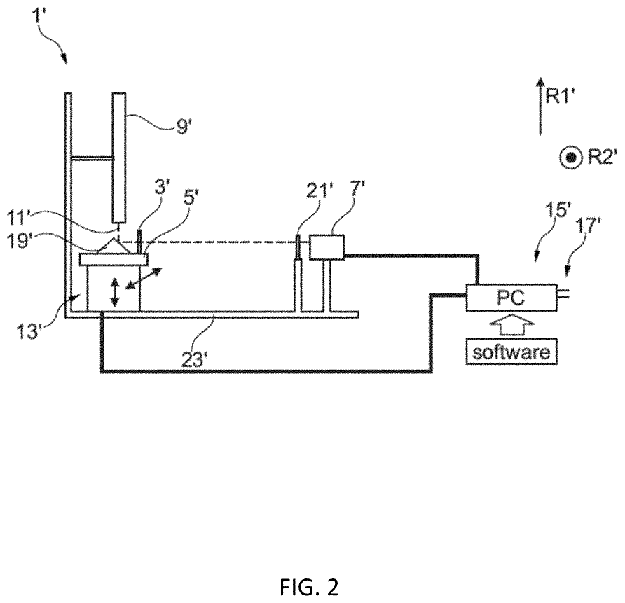

FIG. 2 shows a system 1′ in a second configuration for assessing the quality of at least one component of optical material 3′ of a second type.

The component (of optical material) 3′ whose quality can be assessed with the system 1′ is preferably of flat shape such as of cubic shape (i.e. second type component). The component 3′ has a first center axis which in FIG. 2 runs along a direction parallel to the direction R1′ (i.e. a vertical direction in FIG. 2).

Indeed, system 1′ is similar to system 1 described above with respect to FIG. 1. Hence, for the same structural features the same reference numerals are used, however, single dashed. It is, therefore, also sufficient to describe only the differences between system 1′ and system 1, while for the remainder, reference can be made to the description provided above with respect to system 1 in combination with FIG. 1.

In system 1′ the positioning device 13′ allows for changing the position of the component 3′ along the first direction R1′ and along a second direction R2′ (which is a direction perpendicular to the drawing plane of FIG. 2), while the component 3 is held by the holder device 5′, relative to the light beam 11′. The positioning device 13′ is realized in form of a X-Y-adjustable table (see the arrows indicated at the positioning device 13′ for illustration purposes).

In other words, compared to the positioning device 13 of system 1, the positioning device 13′ of system 1′ performs a displacement in a further direction (perpendicular to the first direction) rather than a rotation.

This modification of the system especially allows the assessment of the quality of non-cylindrical components, such as component 3′ which is of cubic shape in a beneficial manner.

System 1 and system 1′, both, might be either suitable for carrying out and/or configured to carry out, respectively, a method for assessing the quality of at least one component of optical material, such as component 3 or 3′, which has at least one first center axis. The method can be illustrated by means of reference to the systems 1 and 1′ as described before, although it is clear that also other setups than that described with respect to systems 1 and 1′ might be possible for carrying out the method.

The method comprises directing at least one light beam (such as light beam 11 or 11′ of system 1 or 1′) towards at least one detector device (such as detector device 7 or 7′ of system 1 or 1′) such that while changing the position and/or orientation of the component (such as component 3 or 3′ of system 1 or 1′) relative to the light beam, the light beam crosses at least from time to time the component and determining, by means of at least one determination device (such as determining device 15 or 15′ of system 1 or 1′), at least one characterizing value of at least one figure of merit of the component based on analyzing, by means of at least one analyzing device (such as analyzing device 15 or 15′ of system 1 or 1′), the dependency of one or more parameters of the light beam detected by the detector device on the position and/or orientation of the component.

When the light beam crosses the component, the light beam propagates through at least one thickness range of the component. For the cylindrical component of system 1 this thickness range is the shell of the component 3 and for the cubic component 3′ of system 1′ this thickness range is the thickness of the wall of the cubic.

For system 1 the optical element is located at least in part and/or at least from time to time within at least one volume enclosed by the component 3 when the method is carried out. This allows that the light beam always crosses the component, i.e. that at the detector side information of the component is always available.

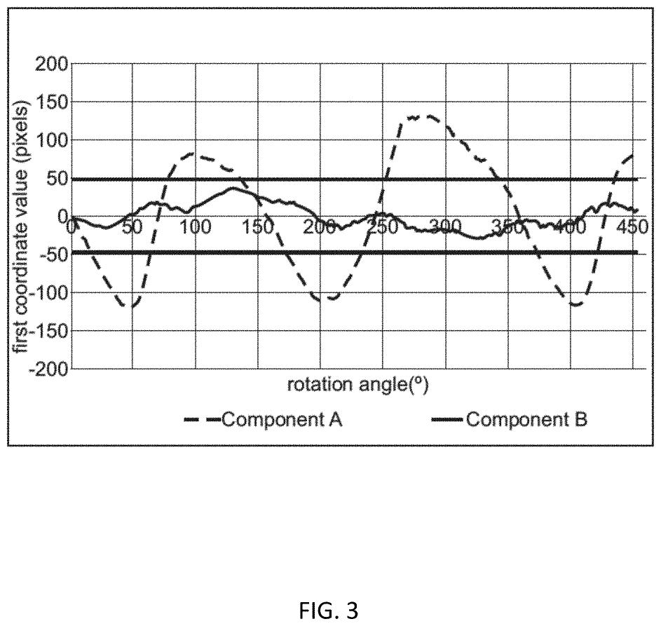

FIG. 3 shows a diagram of the variation of a selected parameter for components of the same type but of different quality.

For example, the figure of merit (whose characterizing value might be desired to be determined with the system 1, the system 1′ and/or by carrying out the respective method as described above) might be directed to local deviation from a cylindrical design of a component of cylindrical shape (such as the component 3). In other words, the comparison of the cylindrical component to an ideal cylindrical shape is of interest.

For assessing this figure of merit, as parameter a first coordinate value of the position of the cross-section of the light beam within the detecting plane might be chosen.

The first coordinate value is on a first coordinate axis, wherein the first coordinate axis is along a third direction. The third direction is perpendicular to the first center axis of the component. For example, for the system 1 the third direction might be perpendicular to the drawing plane of FIG. 1.

FIG. 3 shows a diagram of the variation of the first coordinate value for cylindrical components A and B of two different qualities, which might preferably be obtained with a system such as system 1 described above in combination with FIG. 1. Here the parameter (first coordinate value) is detected by the detector device dependent on the rotation angle of the component, while the position of the component is at a fixed height. In other words, FIG. 3 shows the dependency of the first coordinate value (i.e. the parameter) of the light beam detected by the detector device on the orientation of, respectively, the components A and B.

Determining the characterizing value of the local deviation from a cylindrical design (i.e. the figure of merit) here comprises comparing the result obtained from analyzing the dependency in form of the variation of the parameter, against quantitative reference means. Here, the quantitative reference means comprise an upper threshold value (indicated in FIG. 3 by a solid horizontal line at 50 pixels) and a lower threshold value (indicated in FIG. 3 by a solid horizontal line at -50 pixels).

Thus, the result obtained from analyzing the dependency as shown in FIG. 3 is compared against the upper and lower threshold values. For example if the variation of the parameter exceeds the upper threshold value and/or falls below the lower threshold value, it is possible to classify the component's quality as not acceptable and otherwise as acceptable. In this regard, based on the results shown in FIG. 3, component A might be classified as not acceptable (because the parameter runs outside both thresholds) and component B might be classified as acceptable (because the parameter runs within both thresholds).

The features disclosed in the description, the figures as well as the claims could be essential alone or in every combination for the realization of the disclosure in its different embodiments.

1. A method for assessing the quality of at least one component of optical material which has at least one first center axis, the method comprising:
directing at least one light beam towards at least one detector device such that while changing the position and/or orientation of the component relative to the light beam, the light beam crosses at least from time to time the component; and
determining, with at least one determination device, at least one characterizing value of at least one figure of merit of the component based on analyzing , with at least one analyzing device, the dependency of a parameter of the light beam detected by the detector device on the position and/or orientation of the component.

2. The method according to claim 1, wherein directing the at least one light beam comprises routing the light beam from its at least one light source to the detector device via at least one optical element.

3. The method according to claim 1, wherein, when the light beam crosses the component, the light beam propagates through at least one thickness range of the component.

4. The method according to claim 1, wherein the light beam always crosses the component or crosses the component at different locations for different instances of time.

5. The method according to claim 1, wherein the component is fixedly attached to at least one positioning device, wherein changing the position and/or orientation of the component comprises actuating the positioning device or changing the position and/or orientation of the positioning device.

6. The method according to claim 1, wherein changing the position of the component comprises changing the position of the component along at least one first direction by displacing the positioning device along the first direction.

7. The method according to claim 1, wherein changing the position of the component comprises changing the position of the component along at least one second direction by displacing the positioning device along the second direction.

8. The method according to claim 1, wherein changing the orientation of the component comprises rotating the component around its first center axis or around at least one axis parallel to the incident or the exiting light beam.

9. The method according to claim 1, wherein changing the orientation of the component comprises rotating the component around its first center axis or around at least one axis parallel to the incident or the exiting light beam, by rotating the positioning device around the first center axis or around at least one axis parallel to the incident or the exiting light beam.

10. The method according to claim 1, wherein changing the position and/or orientation of the component comprises changing the position of the component along the first direction and changing the orientation of the component.

11. The method according to claim 1, wherein changing the position and/or orientation of the component comprises changing the position of the component along the first and the second direction.

12. The method according to claim 1, wherein the detector device has at least one detecting plane for detecting the light beam incident to the detector device

13. The method according to claim 1, wherein the parameter is at least one selected from the group consisting of: the area of at least one cross-section of the light beam that lies within the detecting plane of the detector device, the position of the cross-section of the light beam within the detecting plane, and the intensity distribution of the light beam in the detecting plane.

14. The method according to claim 1, wherein the figure of merit is directed to local inhomogeneities, such as at least one local thickness or at least one local refraction index, of,
local deviation from a nominally ideal shaped component of,
local deviation from a cylindric design of,
local defects, such as bubbles or knots, in,
local or global roundness of,
local slope error of,
local drawing lines on,
local shape errors of,
local artifacts of,
local light transmission properties of,
local striae of,
local scratches on,
local variation of physical thickness of,
local variation of optical thickness of, or
local impurities, such as stones or pieces of metal, in, respectively, the component.

15. The method according to claim 1, wherein analyzing the dependency comprises obtaining and evaluating the variation the parameter detected by the detector device has across the different positions and/or orientations of the component.

16. The method according to claim 1, wherein the parameter is a first coordinate value of the position of the cross-section of the light beam in the detecting plane and whose dependency on different positions along the first and/or second direction of the component and/or orientations of the component around its first center axis is analyzed for determining the characterizing value of the local deviation from a cylindrical design, the roundness, the slope error or the drawing lines, respectively, of the component.

17. The method according to claim 1, wherein the parameter is a second coordinate value of the position of the cross-section of the light beam in the detecting plane and whose dependency on different positions along the first and/or second direction of the component and/or orientations of the component around its first center axis is analyzed for determining the characterizing value of the local deviation from a cylindrical design, the roundness, the slope error or the drawing lines, respectively, of the component.

18. The method according to claim 1, wherein the parameter is the area of the cross-section of the light beam in the detecting plane and whose dependency on different positions along the first and/or second direction of the component and/or orientations of the component around its first center axis is analyzed for determining the characterizing value of local deviation from a cylindric design or local defects, respectively, of the component.

19. The method according to claim 1, wherein the parameter is the intensity distribution of the light beam in the detecting plane and whose dependency on different positions along the first and/or second direction of the component and/or orientations of the component around its first center axis is analyzed for determining the characterizing value of local defects or at least one light transmission property, respectively, of the component.

20. A System for assessing the quality of at least one component of optical material, the system comprising:
at least one holder device for holding the component;
at least one detector device;
at least one light source that emits at least one light beam towards the at least one detector device such that the light beam crosses the component at least from time to time while the component is held by the holder device;
at least one positioning device configured to change the position and/or orientation of the component relative to the light beam while the component is held by the holder device,;
at least one analyzing device configured to analyze the dependency of one or more parameters of the light beam detected by the detector device on the position and/or orientation of the component; and
at least one determination device configured to determine at least one characterizing value of at least one figure of merit of the component based on at least one result obtained from the analyzing device.
